(19) United States
(12) Patent Application Publication
(10) Pub. No.: US 2025/0243912 A1
(43) Pub. Date: Jul. 31, 2025

(54) CLUTCH ASSEMBLY FOR SELECTIVELY COUPLING ONE OF A FIRST OUTPUT SHAFT AND A SECOND OUTPUT SHAFT WITH AN INPUT SHAFT, TRANSMISSION UNIT, AND VEHICLE

(71) Applicant: Volvo Car Corporation, Gothenburg (SE)

(72) Inventor: Peter CAIN, Gothenburg (SE)

(73) Assignee: Volvo Car Corporation, Gothenburg (SE)

(21) Appl. No.: 19/059,362

(22) Filed: Feb. 21, 2025

(30) Foreign Application Priority Data
Jan. 27, 2024 (EP) 24160017.0

(51) Int. Cl. F16D 21/06

(52) U.S. Cl. CPC F16D 21/06; F16D 2021/0661

(57) ABSTRACT

In an aspect, the disclosure relates to a clutch assembly for selectively coupling one of a first output shaft and a second output shaft with an input shaft, wherein the clutch assembly comprises: an input flange configured for coupling to the input shaft; a first coupling means rotatable around a first axis; a second coupling means rotatable around a second axis; a first output flange configured for coupling to the first output shaft; and a second output flange configured for coupling to the second output shaft; and a biasing means. Moreover, a transmission unit is presented. The transmission unit comprises the clutch assembly, the input shaft which is drivingly connected to the input flange, the first output shaft drivingly connected to the first output flange and the second output shaft drivingly connected to the second output flange, Furthermore, a vehicle comprising the clutch assembly or the transmission unit is presented.

### CROSS-REFERENCE TO RELATED APPLICATIONS

This application claims the benefit of European Patent Application Number 24160017.0, filed on Feb. 27, 2024, which is hereby incorporated by reference in its entirety.

### TECHNICAL FIELD

The present disclosure relates to a clutch assembly for selectively coupling one of a first output shaft and a second output shaft with an input shaft.

Moreover, the disclosure is directed to a transmission unit.

Furthermore, the disclosure relates to a vehicle comprising such a clutch assembly or such a transmission unit.

### BACKGROUND ART

For vehicles with an internal combustion engine, it is common to have a transmission unit between the internal combustion engine and driven road wheels. Due to a conversion between torque and rotational speed achieved by the transmission unit, the internal combustion engine can be operated in a speed range that is fuel-efficient.

Also in electric vehicles driven by an electric motor, it may be beneficial to apply a transmission unit between the electric motor and the driven road wheels. However, since an electric motor operates efficiently over a broad speed range, transmission units for electric vehicles typically comprise fewer gears than transmission units for vehicles with an internal combustion engine.

### SUMMARY

The following paragraphs present a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

It is an objective of the present disclosure to provide an improved transmission unit which is in particular suitable for an electric vehicle.

The problem is at least partially solved or alleviated by the subject matter of the independent claims of the present disclosure, wherein further examples are incorporated in the dependent claims.

According to a first aspect, there is provided a clutch assembly for selectively coupling one of a first output shaft and a second output shaft with an input shaft. The clutch assembly comprises:
an input flange configured for coupling to the input shaft,
a first coupling means rotatable around a first axis,
a second coupling means rotatable around a second axis,
a first output flange configured for coupling to the first output shaft, and
a second output flange configured for coupling to the second output shaft, and
a biasing means.
   The first coupling means is drivingly connected to the input flange and drivingly connected to the first output flange. The first coupling means drivingly connects the input flange and the first output flange when in an engagement state. The first coupling means drivingly disconnects the input flange and the first output flange when in a disengagement state. The second coupling means is drivingly connected to the input flange and drivingly connected to the second output flange. The second coupling means drivingly connects the input flange and the second output flange when in an engagement state. The second coupling means drivingly disconnects the input flange and the second output flange when in a disengagement state. The second coupling means is biased into the engagement state and the first coupling means is biased into the disengagement state by the biasing means. The input flange may receive a torque from an electric motor of a vehicle via the input shaft. The first output flange and/or the second output flange may provide the torque to driven road wheels of the vehicle via a differential and road wheel drive shafts. Hence, the clutch assembly has the effect that the torque path from the electric motor to the driven road wheels may be selectively varied. The clutch assembly is biased towards a torque path from the electric motor to the driven road wheels via the second coupling means and the second output flange. Consequently, using the torque path from the electric motor to the driven road wheels via the second coupling means and the second output flange does not require any specific actuation. More generally speaking, using the torque path from the electric motor to the driven road wheels via the second coupling means and the second output flange does not require actuation energy. Only if the torque path from the electric motor to the driven road wheels via the first coupling means and the first output flange shall be used, an actuation is necessary which then needs to act against the biasing means. Such a configuration is simple from a structural point of view. From an operational point of view, such a configuration is simple and reliable since, due to the biasing means, an alternative use of the first coupling means and the second coupling means is guaranteed, i.e. errors are reduced or eliminated.

In an example, the first coupling means and/or the second coupling means are clutches, i.e. components configured to drivingly connect two moving or rotating elements with each other, e.g. drive shafts of a drivetrain of the vehicle.

It is noted that even though the above explanations mention a potential use in an electric vehicle, it is also possible to use the clutch assembly according to the present disclosure in a vehicle with an internal combustion engine.

In an example, the second coupling means is axially and/or radially nested in the first coupling means. Axially nested is to be understood as being nested with respect to the first axis of the first coupling means and/or with respect to the second axis of the second coupling means. This means that the first coupling means and the second coupling means at least partially overlap along the first axis and/or the second axis. In an example, the first coupling means and the second coupling means may be located at substantially the same axial position with respect to the first axis and/or the second axis. For this, an outer diameter of at least a portion of the second coupling means needs to be smaller than an outer diameter of at least a portion of the first coupling means. Radially nested is to be understood as being nested with respect to a radial direction defined with respect to the first axis and/or with respect to the second axis. This means that the first coupling means and the second coupling means at least partially overlap along the radial direction defined with respect to the first axis and/or along the radial direction defined with respect to the second axis. In simplified words, a case in which the second coupling means is axially and radially nested in the first coupling means may be described as the second coupling means received within or inside the first coupling means. Axially and/or radially nesting has the effect that the clutch assembly is comparatively small in an axial direction and/or in a radial direction. This saves axial and/or radial space in the drivetrain of the vehicle.

In an example, the first axis and the second axis coincide. Additionally, or alternatively one or more of a middle axis of the input flange, a middle axis of the first output flange and a middle axis of the second output flange coincide. In other words, the respective axes are identical. Put otherwise, these axes are coaxial. This means that the first coupling means and the second coupling means and/or the input flange and/or the first output flange and/or the second output flange rotate around the same axis. This has the effect that an efficient and reliable transmission of torque from the input flange to the first output flange and/or to the second output flange is provided. Moreover, such a clutch assembly is compact.

In an example, the first coupling means is a first multi-plate clutch comprising a plurality of first plates, a first outer plate carrier and a first inner plate carrier. The second coupling means is a second multi-plate clutch, comprising a plurality of second plates, a second outer plate carrier and a second inner plate carrier. Both for the first multi-plate clutch and for the second multi-plate clutch, the plurality of plates comprises a first type of plates that are rotatorily coupled to the respective inner plate carrier. These plates may be called inner plates or inner discs. The plurality of plates also comprises a second type of plates that are rotatorily coupled to the respective outer plate carrier. These plates may be called outer plates or outer discs. In this context, rotatorily coupled means that the plates are coupled to the respective inner plate carrier or outer plate carrier such that they can only rotate together. In other words, a rotatory coupling does not allow for a relative rotation of the parts rotatorily coupled. Both the first type of plates and the second type of plates are axially movable with respect to the respective inner plate carrier and the respective outer plate carrier. An axial direction of the first multi-plate clutch is to be understood as the direction of the first axis. An axial direction of the second multi-plate clutch is to be understood as the direction of the second axis. The first type of plates are alternatingly arranged with the second type of plates. This has the effect that torque may be transmitted between the respective outer plate carrier and the respective inner plate carrier when an axial clamping force is applied to the plurality of respective plates. Such multi-plate clutches have a comparatively high capacity to transfer torque while they are comparatively compact at the same time.

In an example, the first outer plate carrier is fixedly connected to the input flange. Additionally, or alternatively, the first inner plate carrier is fixedly connected to the first output flange. Additionally, or alternatively, the second inner plate carrier is fixedly connected to the second output flange. Additionally, or alternatively, the second outer plate carrier is rotatorily connected to the first outer plate carrier and axially movable relative to the first outer plate carrier. In this context, fixedly connected is to be understood as translatorily and rotatorily connected. This means that the first outer plate carrier and the input flange may be formed by the same part or by fixedly parts connected to one another. Likewise, the first inner plate carrier at the first output flange may be formed by the same part or by fixedly parts connected to one another. Also, the second inner plate carrier and the second output flange may be formed by the same part or by fixedly parts connected to one another. This has the effect that a torque received at the input flange is reliably provided to the first outer plate carrier. Similarly, a torque transmitted to the first inner plate carrier is reliably provided to the first output flange. Also, a torque provided to the second inner plate carrier is reliably provided to the second output flange. Moreover, rotatorily connected parts are parts that can only rotate together. In other words, a rotatory connection does not allow for a relative rotation of the parts rotatorily connected. Thus, the second outer plate carrier being rotatorily connected to the first outer plate carrier and axially movable relative to the first outer plate carrier has the effect that the torque received at the input flange may be reliably provided to the second outer plate carrier via the first outer plate carrier. At the same time, a translatory movement of the second outer plate carrier is decoupled from the first outer plate carrier. This facilitates the switching of the first coupling means between the engaged state and the disengaged state and of the second coupling means between the engaged state and the disengaged state.

In an example, the second outer plate carrier comprises a first abutment portion arranged adjacent to one of the first plates and configured for abutting against one of the first plates. The second outer plate carrier also comprises a second abutment portion arranged adjacent to one of the second plates and configured for abutting against one of the second plates. The second outer plate carrier may be ring-shaped. This has the effect that the first abutment portion may abut against one of the first plates along a full circumference. Thus, the first plates and the first coupling means may be reliably switched between the engaged state and the disengaged state using the outer plate carrier. Furthermore, the second abutment portion may abut against one of the second plates along a full circumference. Thus, the second plates and the second coupling means may be reliably switched between the engaged state and the disengaged state using the outer plate carrier. The first abutment portion and the second abutment portion may be axially shifted. The second abutment portion may be located radially inside with respect to the first abutment portion. This has the effect that, in a configuration in which the first multi-plate clutch and the second multi-plate clutch are axially and/or radially nested into each other, the first abutment portion may abut against one of the first plates on one side with respect to an axial direction and the second abutment portion may abut against one of the second plates on the opposite side with respect to an axial direction. The side of the first plates that does not abut against the first abutment portion of the second outer plate carrier may abut against the first outer plate carrier in an axial direction. The second outer plate carrier is rotatorily connected to the first outer plate carrier. As before, rotatorily connected parts can only rotate together. In other words, a rotatory connection does not allow for a relative rotation of the parts rotatorily connected. This has the effect that there is no difference in rotational speed between the second outer plate carrier and the first outer plate carrier. This has the further effect at the first plates can be reliably clamped between the first outer plate carrier and the first abutment portion of the second outer plate carrier. Altogether also a compact configuration of the clutch assembly is achieved.

In an example, the second outer plate carrier comprises an actuation interface for receiving an axial actuation force. In an example, an actuation disc may abut against the actuation interface of the second outer plate carrier. In another example, the actuation force may be applied on the actuation interface via an axial roller bearing. This has the advantage that an actuator generating the actuation force does not need to turn at the same rotational speed as the actuation interface. In an example, the actuator may be standing still. Thus, an actuation force may be reliably provided at the actuation interface.

According to an aspect of the clutch assembly, the actuation force is applied on the actuation interface via an axial roller bearing.

In an example, the clutch assembly comprises an actuator. The actuator may be drivingly coupled to the actuation interface. Optionally, the actuator may be drivingly coupled to the actuation interface via a bearing, e.g. an axial roller bearing, and/or a disc. This has the effect that the actuator may exercise an axial force onto the second outer plate carrier. This, in turn, may cause the first plates to be clamped between the first outer plate carrier and the first abutment portion of the second outer plate carrier. In other words, the first multi-plate clutch may be closed by an axial actuation force from the actuator. Still in other words, the first coupling means is transferred into the engagement state and the second coupling means is transferred into the disengagement state. Consequently, the input flange may be drivingly connected to the first output flange.

In an example, the biasing means is axially supported on the second outer plate carrier and axially supported on the first outer plate carrier. This has the effect that the biasing means may be mounted to the second outer plate carrier and the first outer plate carrier in a tensed or loaded state. This causes the biasing means to exercise a biasing force onto the second outer plate carrier and the first outer plate carrier. In other words, the biasing force biases the first outer plate carrier and the second outer plate carrier with respect to one another. In case an actuator is provided, the biasing force may act in a direction opposite to the axial actuation force from the actuator. The biasing force causes the first multi-plate clutch to open and the second multi-plate clutch to close. In other words, the first coupling means is biased towards or held in the disengagement state and the second coupling means is biased towards or held in the engagement state. Consequently, the input flange may be drivingly connected to the second output flange using the biasing means. In this state of the clutch assembly, no further actuation force is necessary. Moreover, due to the biasing means, the clutch assembly always assumes a well-defined state.

In an example, the second outer plate carrier comprises a plurality of biasing arms extending axially. The biasing means is axially supported by the plurality of biasing arms. A biasing arm may be understood as a local protrusion of the second outer plate carrier in axial direction. The plurality of biasing arms may be arranged such that they form a ring-shape. This has the effect that the biasing means is not supported along an entire circumference of the second outer plate carrier but only by local portions thereof. Nevertheless, the biasing means is reliably supported, in particular if the biasing arms are distributed. The local portions, meaning the biasing arms, may be arranged along the circumference of the second outer plate carrier. The biasing arms additionally enhance the flexibility in supporting the biasing means on the second outer plate carrier.

According to an aspect of the clutch assembly, the plurality of biasing arms are arranged in a ring-shape.

In case the clutch assembly comprises an actuation interface and biasing arms, the actuation interface may be formed at respective ends of the biasing arms. This has the effect that the axial actuation force from the actuator may be reliably applied to the second outer plate carrier.

In an example, the clutch assembly further comprises an abutment part. The abutment part is rotatorily coupled to the first outer plate carrier and is axially movable relative to the first outer plate carrier. The abutment part comprises an abutment portion arranged adjacent to one of the second plates and configured for abutting against one of the second plates. The abutment part may further be prevented from losing contact with the first outer plate carrier in the axial direction by a first retaining means that may be anchored on the first outer plate carrier. In such a configuration, the abutment part may be limited in an axial movement by the second plates on one axial side and by the retaining means on the respective other axial side. Moreover, as far as the second plates are concerned, the second plates may abut against the second abutment portion of the second outer plate carrier on one axial side. On the opposite axial side, the second plates may abut against the abutment part. As before, rotatorily coupled parts can only rotate together. In other words, a rotatory coupling does not allow for a relative rotation of the parts rotatorily coupled parts. Thus, since both the second outer plate carrier and the abutment part are rotatorily coupled to the first outer plate carrier, there is no difference in rotational speed between the second outer plate carrier and the abutment part. This has the effect that the second plates can be reliably clamped between the second outer plate carrier and the abutment part. The clamping force may be provided by the biasing means. Hence, the clamping force may cause the second multi-plate clutch to close and the first multi-plate clutch to open. Consequently, the input flange may be drivingly connected to the second output flange.

In an example, the biasing arms axially extend through the abutment part. This means that the abutment part comprises holes, openings or cut-outs through which the biasing arms extend. This has the effect that the biasing means may be arranged outside an area between the first multi-plate clutch and the second multi-plate clutch. This facilitates a mountability of the clutch assembly and renders the clutch assembly compact.

In an example, the biasing means comprises one or more spring elements. This has the effect that a biasing force may be reliably applied to the second outer plate carrier.

In an example, the biasing means comprises one or more disc springs, e.g. Belleville washers. When in a tensed or loaded state, the disc springs exercises the biasing force onto the biasing arms of the second outer plate carrier. In a relaxed state of the disc springs, the biasing force created by the disc springs may be reduced or eliminated. This facilitates closing the first multi-plate clutch and opening the second multi-plate clutch.

According to a second aspect, there is provided a transmission unit. The transmission unit comprises:
a clutch assembly according to the present disclosure,
an input shaft
a first output shaft, and
a second output shaft.

A transmission unit comprises: a clutch assembly for selectively coupling one of a first output shaft and a second output shaft with an input shaft, wherein the clutch assembly comprises: an input flange configured for coupling to the input shaft; a first coupling means rotatable around a first axis; a second coupling means rotatable around a second axis; a first output flange configured for coupling to the first output shaft; and a second output flange configured for coupling to the second output shaft; and a biasing means; wherein the first coupling means is drivingly connected to the input flange and drivingly connected to the first output flange; wherein the first coupling means drivingly connects the input flange and the first output flange when in an engagement state; and wherein the first coupling means drivingly disconnects the input flange and the first output flange when in a disengagement state; wherein the second coupling means is drivingly connected to the input flange and drivingly connected to the second output flange, wherein the second coupling means drivingly connects the input flange and the second output flange when in an engagement state; and wherein the second coupling means drivingly disconnects the input flange and the second output flange when in a disengagement state; and wherein the second coupling means is biased into the engagement state and the first coupling means is biased into the disengagement state by the biasing means; wherein the transmission unit further comprises: an input shaft; a first output shaft; and a second output shaft; wherein the input shaft is drivingly connected to the input flange; wherein the first output shaft is drivingly connected to the first output flange; wherein the second output shaft is drivingly connected to the second output flange.

The input shaft is drivingly connected to the input flange. The first output shaft is drivingly connected to the first output flange. The second output shaft is drivingly connected to the second output flange. Due to the clutch assembly, the transmission unit may provide two different gears, i.e. two different torque paths, corresponding to the respective engagement states of the first coupling means and the second coupling means. The first output flange and/or the second output flange may provide the torque to driven road wheels of the vehicle via a differential and road wheel drive shafts. Since the clutch assembly is biased one gear does not require any specific actuation. More generally speaking, one gear does not require actuation energy. Actuation is only necessary for the respective other gear. This actuation needs to act against the biasing means. Such a configuration is simple from a structural point of view. From an operational point of view, such a configuration is simple and reliable since, due to the biasing means, an alternative use of the first coupling means and the second coupling means, i.e. one gear and the other gear, is guaranteed. This reduces an error probability. In an example, the second output shaft is a hollow shaft. The first output shaft is arranged inside the second output shaft. This implies that the first output shaft and the second output shaft share the same middle axis. Such a configuration is very compact.

In an example, the first output shaft is radially supported on the input flange. Additionally, or alternatively, the first output shaft and the second output shaft are radially supported on one another. The first output shaft being radially supported on the input flange implies that the first output shaft and the input flange share the same middle axis. The case of the first output shaft and second output shaft being radially supported on each other implies that the first output shaft and the second output shaft share the same middle axis. Consequently, also the input flange and the second output shaft share the same middle axis. This configuration is structurally simple in the sense that comparatively few bearings are necessary. Moreover, this configuration is space-saving.

In an example, a first gearwheel is fixedly attached to the first output shaft. A second gearwheel is fixedly attached to the second output shaft. A diameter of the first gearwheel may be smaller than a diameter of the second gearwheel. The first gearwheel and the second gearwheel may mesh with a first pinion and a second pinion on a pinion shaft, respectively. The first pinion and the second pinion may be rotatably mounted to the pinion shaft. A coupling means may be provided which allows to selectively couple the first pinion or the second pinion to the pinion shaft in a rotatory manner, i.e. in a manner that the first pinion or the second pinion can only rotate together with the pinion shaft. Thus, when the clutch assembly directs a torque received at the input flange to the first output shaft, the coupling means may rotatorily couple the first pinion with the pinion shaft. When the clutch assembly directs a torque received at the input flange to the second output shaft, the coupling means may rotatorily couple the second pinion with the pinion shaft. This has the effect that a torque coming from the input shaft can be converted into two different torque levels and provided, e.g. to the driven road wheels of the vehicle. When the clutch assembly directs the torque coming from the input shaft to the first output shaft, the torque that is provided, e.g. to the driven road wheels may be higher than the torque that is provided to the driven road wheels when the clutch assembly directs the torque coming from the input shaft to the second output shaft.

According to an aspect, the clutch assembly comprises a first gearwheel fixedly attached to the first output shaft and a second gearwheel fixedly attached to the second output shaft.

According to a third aspect, there is provided a vehicle. The vehicle comprises a clutch assembly according to the present disclosure. Additionally, or alternatively, the vehicle comprises a transmission unit according to the present disclosure. This has the effect that a given torque from the motor of the vehicle can be converted into two different levels of torque and rotational speed, respectively. This way, the electric motor may be operated in an efficient speed range regardless at what speed the vehicle is travelling.

A vehicle comprising a transmission unit wherein the transmission unit comprises a clutch assembly for selectively coupling one of a first output shaft and a second output shaft with an input shaft, wherein the clutch assembly further comprises: an input flange configured for coupling to the input shaft; a first coupling means rotatable around a first axis; a second coupling means rotatable around a second axis; a first output flange configured for coupling to the first output shaft; and a second output flange configured for coupling to the second output shaft; and a biasing means; wherein the first coupling means is drivingly connected to the input flange and drivingly connected to the first output flange; wherein the first coupling means drivingly connects the input flange and the first output flange when in an engagement state; and wherein the first coupling means drivingly disconnects the input flange and the first output flange when in a disengagement state; wherein the second coupling means is drivingly connected to the input flange and drivingly connected to the second output flange, wherein the second coupling means drivingly connects the input flange and the second output flange when in an engagement state; and wherein the second coupling means drivingly disconnects the input flange and the second output flange when in a disengagement state; and wherein the second coupling means is biased into the engagement state and the first coupling means is biased into the disengagement state by the biasing means.

It should be noted that the above examples may be combined with each other irrespective of the aspect involved.

These and other aspects of the present disclosure will become apparent from and elucidated with reference to the examples described hereinafter.

### BRIEF DESCRIPTION OF DRAWINGS

Examples of the disclosure will be described in the following with reference to the following drawings.

FIG. 1 shows a vehicle according to the present disclosure comprising a transmission unit according to the present disclosure, wherein the transmission unit comprises a clutch assembly according to the present disclosure.

FIG. 2 shows the transmission unit of the vehicle of FIG. 1 in a separate view.

FIG. 3 shows a cross-sectional view of the transmission unit of FIG. 2.

FIG. 4 shows the clutch assembly according to the present disclosure in a separate view, wherein the view corresponds to the view of FIG. 3.

FIG. 5 shows a detail V of the clutch assembly of FIG. 4 in a state in which disclosure first coupling means is in a disengagement state and a second coupling means is in an engagement state.

FIG. 6 shows the detail V of the clutch assembly of FIG. 4, wherein the first coupling means is in an engagement state and the second coupling means is in the disengagement state.

### DETAILED DESCRIPTION

The Figures are merely schematic representations and serve only to illustrate examples of the disclosure. Identical or equivalent elements are in principle provided with the same reference signs.

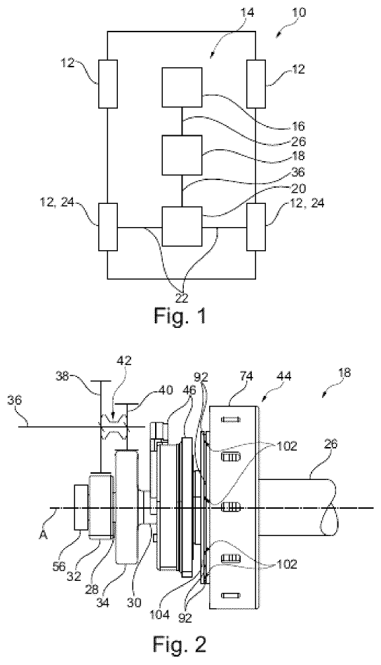

FIG. 1 shows a vehicle 10.

The vehicle 10 comprises four road wheels 12.

The vehicle 10 further comprises an electric drivetrain 14.

The electric drivetrain 14 comprises an electric motor 16, a transmission unit 18, a differential 20 and two road wheel drive shafts 22.

Two of the road wheels 12 are drivingly connected to the differential 20 by the road wheel drive shafts 22. Thus, these two road wheels 12 are driven road wheels 24.

A torque or power provided by the electric motor 16 is converted in the transmission unit 18 and provided to the driven road wheels 24 via the differential 20 and the road wheel drive shafts 22.

This causes the driven road wheels 24 to rotate and, thus, the vehicle 10 to move.

FIG. 2 shows the transmission unit 18 of FIG. 1 in more detail. The transmission unit 18 comprises an input shaft 26, a first output shaft 28 and a second output shaft 30.

A first gearwheel 32 is fixedly connected to the first output shaft 28.

A second gearwheel 34 is fixedly connected to the second output shaft 30.

The transmission unit 18 further comprises a pinion shaft 36, which is only schematically shown.

On the pinion shaft 36, there are a first pinion 38 and a second pinion 40, each being axially and radially supported by a pinion roller bearing.

The first pinion 38 and the second pinion 40 can selectively be drivingly connected to the pinion shaft 36 via a claw coupling 42.

Of course, other coupling means are also conceivable instead of the claw coupling 42.

The first gearwheel 32 meshes with the first pinion 38.

The second gearwheel 34 meshes with the second pinion 40.

A diameter of the first gearwheel 32 is smaller than a diameter of the second gearwheel 34.

Thus, when the first pinion 38 is drivingly coupled to the pinion shaft 36 and when the first gearwheel 32 meshes with the first pinion, the resulting torque on the pinion shaft 36 is higher than when the second pinion 40 is drivingly coupled to the pinion shaft 36 and when the second gearwheel 34 meshes with the second pinion 40.

Consequently, when the first pinion 38 is drivingly coupled to the pinion shaft 36 and when the first gearwheel 32 meshes with the first pinion 38, the resulting rotational speed of the pinion shaft 36 is lower than when the second pinion 40 is drivingly coupled to the pinion shaft 36 and when the second gearwheel 34 meshes with the second pinion 40.

The transmission unit 18 further comprises a clutch assembly 44 and an actuator 46.

The clutch assembly 44 drivingly couples the input shaft 26 with the first output shaft 28 or with the second output shaft 30.

When the actuator 46 exercises an actuation force on the clutch assembly 44, the input shaft 26 is drivingly coupled to the first output shaft 28.

When the actuator 46 does not exercise any actuation force on the clutch assembly 44, the input shaft 26 is drivingly coupled to the second output shaft 30.

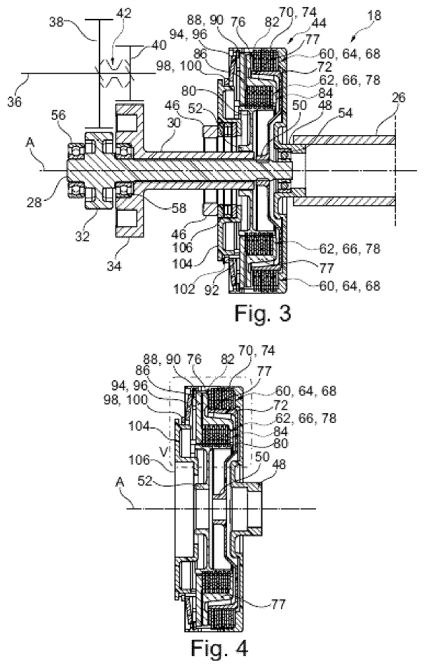

This mechanism will be explained in more detail with respect to FIGS. 3 and 4.

FIG. 3 shows the transmission unit 18 of FIG. 2 in a cross-sectional view.

The second output shaft 30 is hollow.

The first output shaft 28 is arranged inside the second output shaft 30.

The clutch assembly 44, which is also shown in FIG. 4, comprises an input flange 48, a first output flange 50 and a second output flange 52.

The input shaft 26 is drivingly connected to the input flange 48.

The first output shaft 28 is drivingly connected to the first output flange 50.

The second output shaft 30 is drivingly connected to the second output flange 52.

The first output shaft 28 is radially supported in the input flange 48 by a first roller bearing 54.

Additionally, the first output shaft 28 is radially supported on a housing of the transmission unit 18 (not shown) via a second roller bearing 56.

The second output shaft 30 is radially supported on the first output shaft 28 via a third roller bearing 58.

The clutch assembly 44 further comprises first coupling means 60 and second coupling means 62.

In the present example, the first coupling means 60 and the second coupling means 62 are a first multi-plate clutch 64 and a second multi-plate clutch 66, respectively.

The middle axes of the first multi-plate clutch 64, the second multi-plate clutch 66, the input shaft 26, the first output shaft 28 and the second output shaft 30 coincide. Therefore, all middle axes are designated with A.

The first multi-plate clutch 64 has a larger diameter than the second multi-plate clutch 66.

The first multi-plate clutch 64 and the second multi-plate clutch 66 are axially and radially nested into each other.

Due to the coinciding axes A, a torque may be transmitted from the input flange 48 to the first output flange 50 via the first multi-plate clutch 64.

Also, a torque may be transmitted from the input flange 48 to the second output flange 52 via the second multi-plate clutch 66.

Speaking for the transmission unit 18, a torque may be transmitted from the input shaft 26 to the first output shaft 28 via the first multi-plate clutch 64.

Likewise, a torque may be transmitted from the input shaft 26 to the second output shaft 30 via the second multi-plate clutch 66.

In other words, the first multi-plate clutch 64, the first output flange 50, the first output shaft 28 and the first gearwheel 32 relate to a first gear of the electric drivetrain 14 of the vehicle 10.

The second multi-plate clutch 66, the second output flange 52, the second output shaft 30 and the second gearwheel 34 relate to a second gear of the electric drivetrain 14 of the vehicle 10.

The first multi-plate clutch 64 comprises a plurality of first plates 68, a first outer plate carrier 70 and a first inner plate carrier 72.

In the present example, the first outer plate carrier 70 is a clutch basket 74 drivingly connected to the input flange 48. This means that the first outer plate carrier 70 is shaped like a circular cylinder being open at one axial end and closed at the other axial end. The input flange 48 is arranged centrally at the closed axial end.

The first inner plate carrier 72 is drivingly connected to the first output flange 50. In the present example, this connection is formed by a ring-plate shaped section of the part forming the first inner plate carrier 72 and the first output flange.

A first type of the first plates 68 is rotatorily coupled to the first outer plate carrier 70. This means that the first type of the first plates 68 can only rotate together with the first outer plate carrier 70. This type of first plates 68 is axially movable with respect to the first outer plate carrier 70. These first plates 68 may be called outer plates or outer discs.

A second type of the first plates 68 is rotatorily coupled to the first inner plate carrier 72. This means that the second type of the first plates 68 can only rotate together with the first inner plate carrier 72. This type of first plates 68 are axially movable with respect to the first inner plate carrier 72. These first plates 68 may be called inner plates or inner discs.

The first type of first plates 68 and the second type of first plates 68 are arranged in an alternating manner along the axial direction.

A driving connection between the first inner plate carrier 72 and the first outer plate carrier 70 is achieved through a clamping force that creates friction between the first type and the second type of the first plates 68.

The same principle as outlined for the first multi-plate clutch 64 also applies to the second multi-plate clutch 66.

For this, the second multi-plate clutch 66 comprises a second outer plate carrier 76, a plurality of second plates 78 and a second inner plate carrier 80.

The second outer plate carrier 76 is rotatorily connected to the clutch basket 74. This means that the second outer plate carrier 76 can only rotate together with the clutch basket 74. At the same time, the second outer plate carrier 76 is axially movable with respect to the clutch basket 74. To this end, a toothing may be provided at an outer circumference of the second outer plate carrier 76 and a meshing toothing may be provided at an inner circumference of the clutch basket 74.

The second outer plate carrier 76 comprises a first abutment portion 82 which is arranged axially adjacent to the first plates 68 such that the first plates 68 may abut against the first abutment portion 82 on one side. The first abutment portion 82 is formed as a ring-shaped plate.

On the opposing side, the first plates 68 may abut against the clutch basket 74.

The second outer plate carrier 76 also comprises a second abutment portion 84 against which the second plates 78 abut on one side. Also, the second abutment portion 84 is formed as a ring-shaped plate.

The second abutment portion 84 is arranged adjacent to the second plates 78 such that the second plates 78 may abut against the second abutment portion 84.

A carrier portion 77, which supports the second plates 78, is arranged radially between the first abutment portion 82 and the second abutment portion 84. Also, the carrier portion 77 is ring-shaped.

The clutch assembly 44 also comprises an abutment part 86.

The abutment part is generally ring-shaped.

Like the second outer plate carrier 76, the abutment part 86 is rotatorily connected to the clutch basket 74 but axially movable with respect to the clutch basket 74. To this end, a toothing may be provided at an outer circumference of the abutment part 86 and a meshing toothing may be provided at an inner circumference of the clutch basket 74. Thus, the abutment part 86 may only rotate together with the clutch basket 74.

Along an axial direction, the abutment part 86 is arranged adjacent to the first abutment portion 82 of the second outer plate carrier 76. At the same time, the abutment part 86 is located on an opposite side of the second outer plate carrier 76 with respect to the first plates 68.

Moreover, the axial movability of the abutment part 86 is delimited by a first retaining means 88, which in the present example is a first locking ring 90 mounted on an inner circumference of the clutch basket 74.

The first retaining means 88 and the second outer plate carrier 76 are located on opposite axial sides of the abutment part 86.

The abutment part 86 also comprises an abutment portion which is located adjacent to the second plates 78 such that the second plates 78 may abut against the abutment portion of the abutment part 86.

The second outer plate carrier 76 further comprises a plurality of biasing arms 92.

The biasing arms 92 extend axially through the abutment part 86.

This means that the biasing arms 92 extend on one axial side of the abutment part 86 and the first abutment portion 82, the second abutment portion 84 and the carrier portion 77 of the second outer plate carrier 76 extend on an opposite side of the abutment part 86.

The clutch assembly 44 further comprises a biasing means 94, which in the present case is a disc spring, more precisely a Belleville washer 96.

The Belleville washer 96 is axially supported on the biasing arms 92 and on the clutch basket 74.

In more detail, the Belleville washer 96 is axially supported on the clutch basket 74 via the first locking ring 90. On the biasing arms 92, the Belleville washer 96 is axially supported via a second retaining means 98, which in the present example is a second locking ring 100.

Thus, the Belleville washer 96 is arranged axially between the first locking ring 90 and the second locking ring 100.

The Belleville washer 96 creates a biasing force subjecting the first locking ring 90 and the second locking ring 100 to a load oriented such that it tries to push the first locking ring 90 and the second locking ring 100 away from one another.

Due to the above-mentioned configuration of the clutch assembly 44, the abutment part 86, more precisely the abutment portion is biased towards the second plates 78 in a first axial direction and the second abutment portion 84 is biased towards the second plates 78 in a second axial direction-oriented opposite to the first axial direction. Thus, the biasing means 94 generates a clamping force acting onto the second multi-plate clutch 66. Thereby, the second multi-plate clutch 66 is closed and the input flange 48 and the second output flange 52 are drivingly connected via the second multi-plate clutch 66.

At the same time, the first abutment portion 82 is biased away from the first plates 68 such that the first multi-plate clutch 64 is opened. Thus, there is no driving connection between the input flange 48 and the first output flange 50.

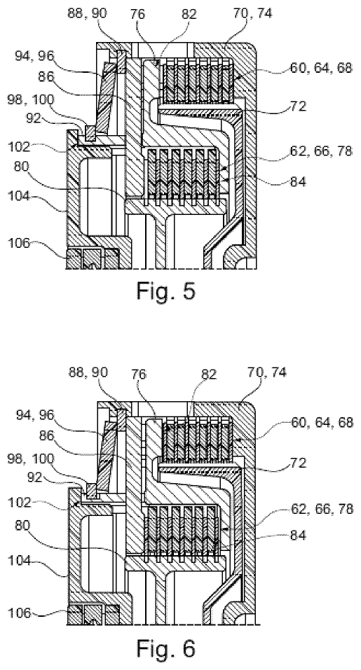

In other words, the second coupling means 62 in the form of the second multi-plate clutch 66 is biased into the engagement state and the first coupling means 60 in the form of the first multi-plate clutch 64 is biased into the disengagement state by the biasing means 94. This can be seen from the gap between the first abutment portion 82 and the first plates 68 in FIG. 5.

Moreover, the biasing arms 92 comprise an actuation interface 102 for receiving an axial actuation force that acts in an opposite direction than the biasing force.

In the present example the actuation interface 102 is formed by the axial end faces of the biasing arms 92.

In the present example, the transmission unit 18 comprises a disc 104 which may also be called an actuation disc. The disc 104 abuts against the actuation interface 102.

Additionally, an axial roller bearing 106 is provided which contacts the disc 104 at an axial side opposite to the biasing arms 92.

An axial actuation force may be generated by the actuator 46 and may be applied on the axial roller bearing 106. This actuation force then is transmitted to the actuation interface via the disc 104.

The axial roller bearing 106 has the advantage that the actuator 46 may be at a standstill while the remaining components of the transmission unit 18 are turning.

Due to the above-mentioned configuration, the actuation force acts against the load resulting from the biasing means 94.

Moreover, the actuation force moves the first abutment portion 82 axially towards the first plates 68 and moves the second abutment portion 84 axially away from the second plates 78. Thus, the actuation force acts as a clamping force onto the first multi-plate clutch 64. Thereby, the first multi-plate clutch 64 is closed and the input flange 48 and the first output flange 50 are drivingly connected. At the same time, the second multi-plate clutch 66 is opened, meaning that there is no driving connection between the input flange 48 and the second output flange 52.

In other words, due to the actuation force, the second coupling means 62 in the form of the second multi-plate clutch 66 is transferred into the disengagement state and the first coupling means 60 in the form of the first multi-plate clutch 64 is transferred into the engagement state. This can be seen from the gap between the second abutment portion 84 and the second plates 78 in FIG. 6.

Generally speaking, when the electric drivetrain 14 of the vehicle 10 may be transferred into first gear, by the actuation force acting onto the axial roller bearing 106. This may cause frictional losses. However, due to the fact that the clutch basket 74, the second outer plate carrier 76 and the disc 104 are expected to rotate at low speed when the electric drivetrain 14 is in first gear, these losses may not be significant.

When the electric drivetrain 14 of the vehicle 10 is in second gear, an actuation force acting onto the axial roller bearing 106 is not necessary. This eliminates frictional losses in the axial roller bearing 106. Due to the fact that the clutch basket 74, the second outer plate carrier 76 and the disc 104 are expected to rotate at high speed when the electric drivetrain 14 is in second gear, it is important to eliminate frictional losses in the axial roller bearing 106 as these losses may indeed be significant.

In summary, the transmission unit 18 and/or the clutch assembly 44 may be operated as follows.

In a first step, a vehicle 10 with a transmission unit 18 and/or a clutch assembly 44 is provided.

The transmission unit 18 and/or the clutch assembly 44 are in an initial state.

In the initial state, no actuation force is provided. This means that the biasing means 94 is acting on the remaining components of the clutch assembly 44. Thus, the second coupling means 62 is in the engagement state and the first coupling means 60 is in the disengagement state.

In other words, the electric drivetrain 14 of the vehicle 10 and the transmission unit 18 is in second gear.

In a second step, an axial actuation force is provided through the actuator 46 via the axial roller bearing 106 and the disc 104 to the biasing arms 92 of the second outer plate carrier 76.

This causes the first multi-plate clutch 64 to close and the second multi-plate clutch 66 to open.

In other words, the input shaft 26 and the first output shaft 28 are drivingly connected. Thus, the second coupling means 62 is in the disengagement state and the first coupling means 60 is in the engagement state.

Still in other words, the electric drivetrain 14 of the vehicle 10 and the transmission unit 18 is in first gear.

It is noted that, the order of the first step and the second step may also be changed. This means that the electric drivetrain 14 of the vehicle 10 may shift from first gear back into second gear. In this case, the actuation force is withdrawn when the electric drivetrain 14 is in second gear.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the term.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances. As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein the term “component” refers to a distinct and identifiable part, element, subsystem, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software, and/or other engineering elements.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software product.

Other specific forms may embody the present disclosure without departing from its spirit or characteristics. The described embodiments are in all respects illustrative and not restrictive. Therefore, the appended claims rather than the description herein indicate the scope of the disclosure. All variations which come within the meaning and range of equivalency of the claims are within their scope.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

### LIST OF REFERENCE SIGNS

10 vehicle
12 road wheel
14 electric drivetrain
16 electric motor
18 transmission unit
20 differential
22 road wheel driveshaft
24 driven road wheel
26 input shaft
28 first output shaft
30 second output shaft
32 first gearwheel
34 second gearwheel
36 pinion shaft
38 first pinion
40 second pinion
42 claw coupling
44 clutch assembly
46 actuator
48 input flange
50 first output flange
52 second output flange
54 first roller bearing
56 second roller bearing
58 third roller bearing
60 first coupling means
62 second coupling means
64 first multi-plate clutch
66 second multi-plate clutch
68 first plate
70 first outer plate carrier
72 first inner plate carrier
74 clutch basket
76 second outer plate carrier
77 carrier portion
78 second plate
80 second inner plate carrier
82 first abutment portion
84 second abutment portion
86 abutment part
88 first retaining means
90 first locking ring
92 biasing arm
94 biasing means
96 Belleville washer
98 second retaining means
100 second locking ring
102 actuation interface
104 disc
106 axial roller bearing
A middle axes

1. A clutch assembly for selectively coupling one of a first output shaft and a second output shaft with an input shaft, wherein the clutch assembly comprises:
an input flange configured for coupling to the input shaft;
a first coupling means rotatable around a first axis;
a second coupling means rotatable around a second axis;
a first output flange configured for coupling to the first output shaft; and
a second output flange configured for coupling to the second output shaft; and
a biasing means;
wherein the first coupling means is drivingly connected to the input flange and drivingly connected to the first output flange;
wherein the first coupling means drivingly connects the input flange and the first output flange when in an engagement state; and wherein the first coupling means drivingly disconnects the input flange and the first output flange when in a disengagement state;
wherein the second coupling means is drivingly connected to the input flange and drivingly connected to the second output flange, wherein the second coupling means drivingly connects the input flange and the second output flange when in an engagement state; and wherein the second coupling means drivingly disconnects the input flange and the second output flange when in a disengagement state; and
wherein the second coupling means is biased into the engagement state and the first coupling means is biased into the disengagement state by the biasing means.

2. The clutch assembly of claim 1, wherein the second coupling means is one or more of axially and radially nested in the first coupling means.

3. The clutch assembly of claim 1, wherein one or more of the first axis and the second axis coincide and one or more of a middle axis of the input flange, a middle axis of the first output flange and a middle axis of the second output flange coincide.

4. The clutch assembly of claim 1, wherein the first coupling means is a first multi-plate clutch comprising a plurality of first plates, a first outer plate carrier and a first inner plate carrier; and
wherein the second coupling means is a second multi-plate clutch, comprising a plurality of second plates, a second outer plate carrier and a second inner plate carrier.

5. The clutch assembly of claim 4, wherein one or more of the first outer plate carrier is fixedly connected to the input flange, the first inner plate carrier is fixedly connected to the first output flange, the second inner plate carrier is fixedly connected to the second output flange; and the second outer plate carrier is rotatorily connected to the first outer plate carrier and axially movable relative to the first outer plate carrier.

6. The clutch assembly of claim 4, wherein the second outer plate carrier comprises: a first abutment portion arranged adjacent to one of the first plates and configured for abutting against one of the first plates; and wherein the second outer plate carrier comprises a second abutment portion arranged adjacent to one of the second plates and configured for abutting against one of the second plates.

7. The clutch assembly of claim 4, wherein the second outer plate carrier comprises: an actuation interface for receiving an axial actuation force.

8. The clutch assembly of claim 4, wherein the biasing means is axially supported on the second outer plate carrier and axially supported on the first outer plate carrier.

9. The clutch assembly of claim 8, wherein the second outer plate carrier comprises: a plurality of biasing arms extending axially; and wherein the biasing means is axially supported by the plurality of biasing arms.

10. The clutch assembly of claim 4, further comprises: an abutment part, wherein the abutment part is rotatorily coupled to the first outer plate carrier and is axially movable relative to the first outer plate carrier, wherein the abutment part comprises an abutment portion arranged adjacent to one of the second plates and configured for abutting against one of the second plates.

11. The clutch assembly of claim 10, wherein the biasing arms axially extend through the abutment part.

12. The clutch assembly of claim 6, wherein the first abutment portion and the second abutment portion are axially shifted.

13. The clutch assembly of claim 7, comprises an actuator drivingly coupled to the actuation interface.

14. The clutch assembly of claim 7, wherein the axial actuation force is applied on the actuation interface via an axial roller bearing.

15. The clutch assembly of claim 9, wherein the plurality of biasing arms are arranged in a ring-shape.

16. The clutch assembly of claim 1, wherein the clutch assembly comprises a first gearwheel fixedly attached to the first output shaft and a second gearwheel fixedly attached to the second output shaft.

17. A transmission unit comprises:
a clutch assembly for selectively coupling one of a first output shaft and a second output shaft with an input shaft, wherein the clutch assembly comprises:
an input flange configured for coupling to the input shaft;
a first coupling means rotatable around a first axis;
a second coupling means rotatable around a second axis;
a first output flange configured for coupling to the first output shaft; and
a second output flange configured for coupling to the second output shaft; and
a biasing means;
wherein the first coupling means is drivingly connected to the input flange and drivingly connected to the first output flange;
wherein the first coupling means drivingly connects the input flange and the first output flange when in an engagement state; and wherein the first coupling means drivingly disconnects the input flange and the first output flange when in a disengagement state;
wherein the second coupling means is drivingly connected to the input flange and drivingly connected to the second output flange, wherein the second coupling means drivingly connects the input flange and the second output flange when in an engagement state; and wherein the second coupling means drivingly disconnects the input flange and the second output flange when in a disengagement state; and
wherein the second coupling means is biased into the engagement state and the first coupling means is biased into the disengagement state by the biasing means;
wherein the input shaft is drivingly connected to the input flange;
wherein the first output shaft is drivingly connected to the first output flange; and
wherein the second output shaft is drivingly connected to the second output flange.

18. The transmission unit of claim 17, wherein the second output shaft is a hollow shaft and wherein the first output shaft is arranged inside the second output shaft.

19. The transmission unit of claim 17, wherein one or more of the first output shaft is radially supported on the input flange and the first output shaft and the second output shaft are radially supported on one another.

20. A vehicle comprising a transmission unit, wherein the transmission unit comprises a clutch assembly for selectively coupling one of a first output shaft and a second output shaft with an input shaft, wherein the clutch assembly further comprises:
an input flange configured for coupling to the input shaft;
a first coupling means rotatable around a first axis;
a second coupling means rotatable around a second axis;
a first output flange configured for coupling to the first output shaft; and
a second output flange configured for coupling to the second output shaft; and;
a biasing means;
wherein the first coupling means is drivingly connected to the input flange and drivingly connected to the first output flange;
wherein the first coupling means drivingly connects the input flange and the first output flange when in an engagement state; and wherein the first coupling means drivingly disconnects the input flange and the first output flange when in a disengagement state; wherein the second coupling means is drivingly connected to the input flange and drivingly connected to the second output flange, wherein the second coupling means drivingly connects the input flange and the second output flange when in an engagement state; and wherein the second coupling means drivingly disconnects the input flange and the second output flange when in a disengagement state; and wherein the second coupling means is biased into the engagement state and the first coupling means is biased into the disengagement state by the biasing means.
